(19) United States
(12) Patent Application Publication
(10) Pub. No.: US 2011/0007205 A1
(43) Pub. Date: Jan. 13, 2011

(54) Rear to forward facing camera adapter

(75) Inventor: Mathew Lee, Oklahoma City, OK (US)

Correspondence Address: Dechnia LLC;c/o Bryan Lee, 3215 Greenmoor Court, Colorado Springs, CO, 80920, US

(73) Assignee: Dechnia, LLC

(21) Appl. No.: 12/802,470

(22) Filed: Jun. 8, 2010

Related U.S. Application Data
(60) Provisional application No. 61/223,829, filed on Jul. 8, 2009.

(51) Int. Cl. H04N 5/238

(52) U.S. Cl. 348/369; 348/E05.024

(57) ABSTRACT

The invention takes a rear facing camera, such as those found on a mobile phone, and turns it into a forward facing camera, enabling self portrait pictures and video to be taken and viewed simultaneously. Currently, simultaneous audio and video conversations (such as mobile to mobile video conferencing) are only possible with devices that have a forward facing camera (because the user must both be able to see and be seen by the person on the other line). The invention makes a device with only a rear facing camera into a usable video phone by turning the image from rear facing to forward facing.

This is based on a Provisional Patent Ser. No. 61/223,829

### BACKGROUND INFORMATION AND PRIOR ART

Many devices, such as cell phones, have an away facing camera (from here known as a rear facing camera), which enables pictures and video to be captured away from the holder of the device. This orientation does not allow for the camera operator to easily take pictures of him or herself. It is possible to take a picture but it requires that the operator look away from the user interface. The invention gives the user of a device that has a rear facing camera the ability to comfortably capture a self-portrait image while viewing the picture at the same time.

### SUMMARY OF INVENTION

The invention takes a rear facing camera, such as those found on a mobile phone, and turns it into a forward facing camera, enabling self portrait pictures and video to be taken and viewed simultaneously. Currently, simultaneous audio and video conversations (such as mobile to mobile video conferencing) are only possible with devices that have a forward facing camera (because the user must both be able to see and be seen by the person on the other line). The invention makes a device with only a rear facing camera into a usable video phone by turning the image from rear facing to forward facing.

### DETAILS OF INVENTION

The invention is an adapter that attaches to a device, such as those found on phones, and redirects a rear facing camera back to the user. One such method to attached the invention to the device is to use two small suction cups (see FIG. 1), which are removed easily by peeling up the edge of the suction cups near the edge of the phone (see FIG. 2). Other methods used to attach the device may include: one suction cup, multiple suction cups, Velcro, mechanical clip, tape, or other means.

The invention not only makes a rear facing camera a forward facing camera but it also corrects the orientation of the image as well. One implementation of the invention uses multiple mirrors (see FIG. 3) with the first at 45 degrees to the camera lens and the next at 90 degrees to turn the camera direction while also correcting the orientation of the image as well. If only one mirror is used (such as taking a picture in front of a bathroom mirror), a hat or shirt with words will be captured backwards. With this invention, the image is corrected as well. Other methods used to implement this invention include but are not limited to the use of multiple mirrors and/or fiber optics (see FIG. 4).

### LIST OF FIGURES

In the drawings, which form a part of this specification,

FIG. 1 is a view of the device being applied using two suction cups.

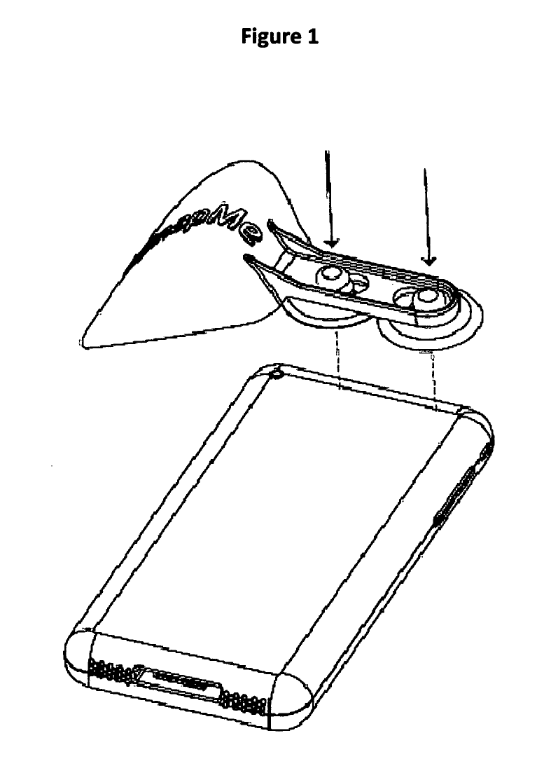

FIG. 2 is a view of an attached device being removed.

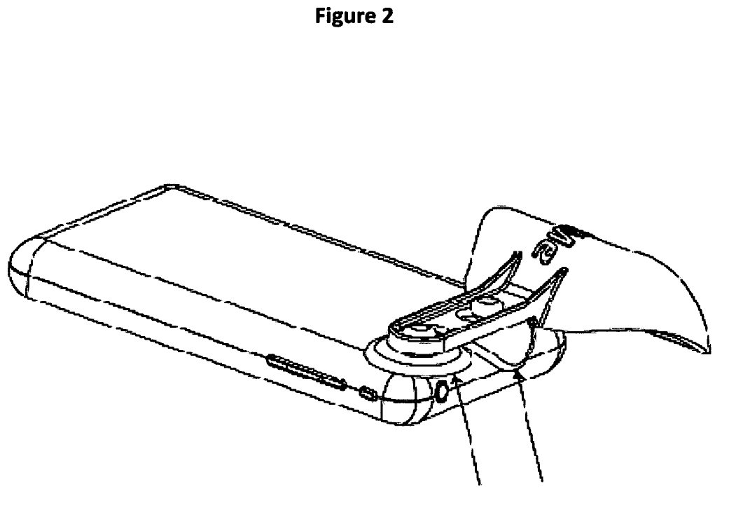

FIG. 3 shows a front perspective view and a back perspective view of two mirrors turning the image

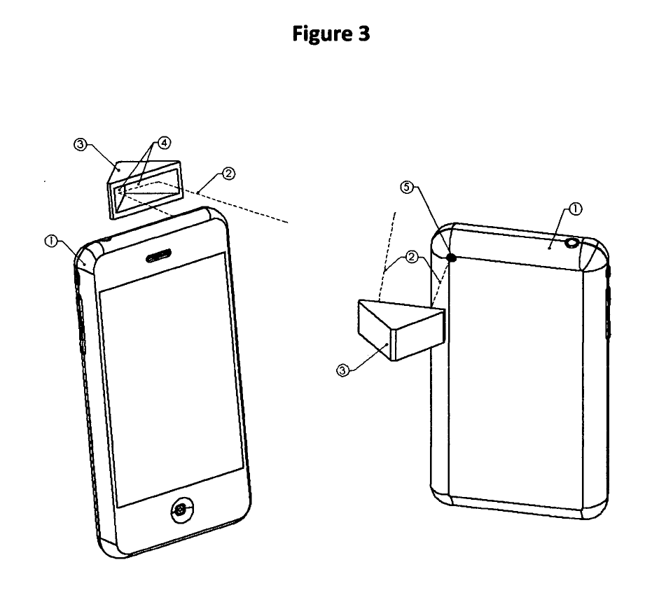

FIG. 4 shows a back perspective view and a top perspective view of fiber optics turning the image

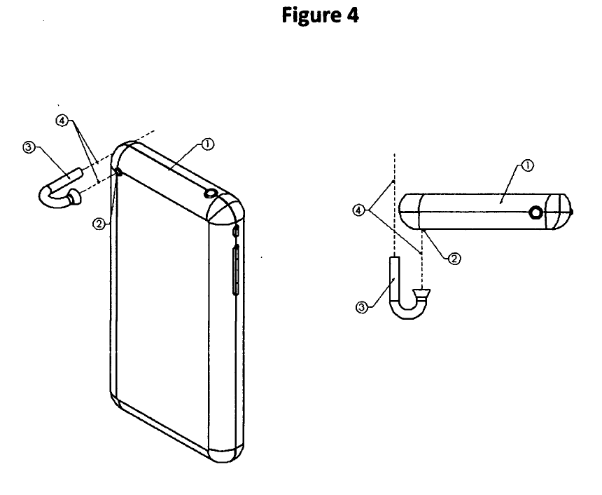

### TWO EXAMPLES OF INTENDED USE

Enables cell phone self portrait pictures to be taken and viewed simultaneously.

Enables cell phone video chat on phones that only have a forward facing camera.

The embodiments of the invention in which an exclusive property or privilege is claimed are defined as follows:

1. The invention takes a rear facing camera, such as those found on a mobile phone, and turns it into a forward facing camera, enabling self portrait pictures to be taken and viewed simultaneously.

2. The invention enables video chat on devices, such as those found on a mobile phone, that only have a forward facing camera.

3. The invention corrects the orientation of the image by the use of multiple mirrors.
